(19) United States
(12) Patent Application Publication
(10) Pub. No.: US 2010/0022300 A1
(43) Pub. Date: Jan. 28, 2010

(54) DEVICE WITH SPATIALLY UNRESTRICTED FORCE FEEDBACK

(75) Inventors: Po-Chang Chen, Taipei County (TW); Chih-Hao Liu, Taichung City (TW); Feng-Hsiang Lo, Hsinchu County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Industrial Technology Research Institute, Hsin-Chu (TW)

(21) Appl. No.: 12/498,007

(22) Filed: Jul. 6, 2009

(30) Foreign Application Priority Data
Jul. 23, 2008 (TW) 097127922

(51) Int. Cl. A63F 13/00

(52) U.S. Cl. 463/30; 463/38

(57) ABSTRACT

A device with spatially unrestricted force feedback is disclosed, which comprises: a base, a gyro assembly including a first actuator and a flywheel; the first actuator connecting and driving the flywheel by a first shaft, and a second actuator fixed on the base and connecting and exerting a torque to the gyro assembly by a second shaft; wherein the first shaft and second shaft are perpendicular to each other.

### FIELD OF THE INVENTION

The present invention relates to a device with spatially unrestricted force feedback, and more particularly, to a force feedback device capable of generating a spatially unrestricted force feedback without having to be arranged at a fixed end.

### BACKGROUND OF THE INVENTION

With rapid advance of 3C industry, consumers' quests regarding to better audio and video effects and improved interactive quality are becoming more and more demanding. However, the quest for improved interactive quality had long been overlooked since most manufacturers had focused their efforts for bettering audio and video effects. Thus, there is little notable improvement with regard to the touch interaction, such as touch control and haptic feedback.

Generally, most touch interactive devices are control devices that are designed to issue a command to a machine in response to the touching of its touch switch or sensor for enabling the machine to perform a predetermined operation in response to the command. Yet, there are few such touch interactive devices capable of generating a feedback force for interaction.

The so-called force feedback device is a device capable of using actuators to generate a reactive force on a user's hand for imitating a real-world sensation of collision or impact, and thereby, interacting with a virtual object in an virtual environment. There are already two types of force feedback device currently available on the market. One of which is the vibration feedback device, which is the device that plays low-fidelity shakes or vibrations for informing or alerting its user. Another one is the force feedback joystick which is the device capable of providing the user with high-fidelity tactile sensations, but it is generally required to be fixed on either a table top or a platform for preventing the same from moving during operation. Nevertheless, since the vibration feedback device can only generate monotonous vibrating reaction and the force feedback joystick is restricted by its poor portability, the interaction effects provided by both the aforesaid feedback devices can no longer satisfy today's consumers.

It is not until the Year 2006 that Nintendo released its “Wii” console which is considered to be a revolutionary interactive apparatus. The distinguishing feature of the Wii console is its wireless controller, the Wii Remote, which is an integrated joystick device comprising a remote control, a microphone and a speaker, capable of wirelessly communicating with its game console in a manner that the game console can direct the Wii remote to issue a force feedback in response to the physical motion of a user, such as swinging a bat/club, as the physical motion of the user can be detected by the accelerators embedded in the Wii remote. The revolutionary Wii remote not only is an improved joystick, but also is a TV remote control sized controller suitable to be held in one hand. However, while operating in free space, the force feedback from the Wii remote is still similar to those conventional feedback devices so that there are still plenty of inadquacies left to be improved when it comes to the truthfulness of virtual reality.

There are already many studies related to such force feedback apparatus. One of which is a device for directional tactile sensations disclosed in U.S. Pat. No. 7,084,854. One of the embodiments shown in the aforesaid disclosure is a mouse device, which basically is comprised of a harmonic actuator assembly, a top portion, a base portion and a printed circuit board. Operationally, the actuator assembly will output an inertial force to the top potion where it is felt by a user holding the mouse device as force feedback. Furthermore, in another embodiment of the aforesaid disclosure, the mouse device is configured with two sets of vibrating elements to be used for causing two directional inertial vibrations along an X-axis and a Y-axis of a Cartesian coordination system. As the X-axis and the Y-axis of the Cartesian coordination system are orthogonal to each other, harmonic vibrations of different direction can be achieved by the control of the vibration phase of the two sets of vibrating elements.

Another such study is a directional haptic feedback device for game controllers, disclosed in U.S. Pat. No. 7,182,691. The directional haptic feedback apparatus uses two rotating eccentric masses to create centrifugal forces that cause directional inertial vibrations in the housing of the device, whereas the two eccentric masses are driven to rotate by two actuators in respective. In an exemplary embodiment of the aforesaid disclosure, rotary shafts of the eccentric masses are arranged about parallel with each other so that a combined centrifugal force resulting from the rotation of the masses is generated. When the masses are rotating with different phase differences, different directional inertial outputs can be felt by the user holding the device, that is, the amount of phase difference between the two rotating masses determines in which direction the resultant inertial force is being outputted as it is directly resulted from the combination of the centrifugal forces from each mass.

One another such study is a gyro-stabilized platform for force feedback applications, disclosed in U.S. Pat. No. 5,754,023. In one embodiment, one or more orthogonally oriented rotating gyroscopes are used to provide a stable body or platform on which a force-reflecting device can be mounted, thereby coupling reaction forces to the user without the need for connection to a fixed frame. As the gyro-stabilized platform, being received in a rectangle-shaped frame, is formed by a set of mutually perpendicular flywheels that are driven to rotate by motors according to certain angular accelerations, a reactive torque resulting from inertia of the angularly accelerating flywheels will be exerted on the frame whereas the magnitude of the reactive torque is in direct proportion to the moment of inertia of the flywheels as well as their angular accelerations. Therefore, as the frame is designed to be held in user's hand, different linear feedback forces can be felt by the user by the control of the motor outputs or the angular accelerations of the flywheels.

It is in need of a device with spatially unrestricted force feedback, capable of generating feedback forces for imitating a real-world sensation like a pull or torsion, and thereby, interacting with a virtual object in a virtual environment. Moreover, such devices should be able to be mounted on a spatially unrestricted operating platform, such as a joystick, a cellular phone or a remote control, etc.

### SUMMARY OF THE INVENTION

The present invention provides a device with spatially unrestricted force feedback capable of using its single-axis or multi-axis structure and gyro assembly to generate a continuous feedback torque.

Moreover, the present invention provides a device with spatially unrestricted force feedback, comprising: a base; a gyro assembly, including a first actuator and a flywheel; and a second actuator; wherein, the first actuator is connected with the flywheel by a first shaft for driving the same to rotate; the second actuator is disposed fixedly on the base while connecting to the gyro assembly by a second shaft for exerting a torque to the same; and the first shaft and second shaft are perpendicular to each other.

In addition, the present invention further provides a system with spatially unrestricted force feedback, being adapted for receiving an external signal, comprising: a force feedback device, having: a base, a gyro assembly configured with a first actuator and a flywheel, and a second actuator; a driving circuit, electrically connected with the force feedback device for amplifying control signals of the first and the second actuators; and a control unit, electrically connected with the driving circuit for calculating an force feedback value according to the received external signal so as to direct the driving circuit to drive the force feedback device for generating a feedback torque in accordance with the force feedback value; wherein, the first actuator is connected with the flywheel by a first shaft for driving the same to rotate; the second actuator is disposed fixedly on the base while connecting to the gyro assembly by a second shaft and exerting a torque to the same; and the first shaft and second shaft are perpendicular to each other.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A is a schematic diagram showing the appearance of a device with spatially unrestricted force feedback according to an exemplary embodiment of the present invention.

FIG. 1B is a schematic diagram showing the appearance of a device with spatially unrestricted force feedback with some components being omitted according to an exemplary embodiment of the present invention.

FIG. 1C is a schematic diagram used for illustrating the operating principle of a device with spatially unrestricted force feedback according to an exemplary embodiment of the present invention.

FIG. 1D is a schematic diagram showing a system with spatially unrestricted force feedback utilizing the device of FIG. 1A according to an exemplary embodiment of the present invention.

FIG. 1E is a schematic diagram showing a system with spatially unrestricted force feedback utilizing the device of FIG. 1A according to another exemplary embodiment of the present invention.

FIG. 2A is a schematic view showing a system with spatially unrestricted force feedback according to an exemplary embodiment of the present invention.

FIG. 2B is a schematic view showing a system with spatially unrestricted force feedback according to another exemplary embodiment of the present invention.

FIG. 3 shows an application of a device with spatially unrestricted force feedback according to an exemplary embodiment of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

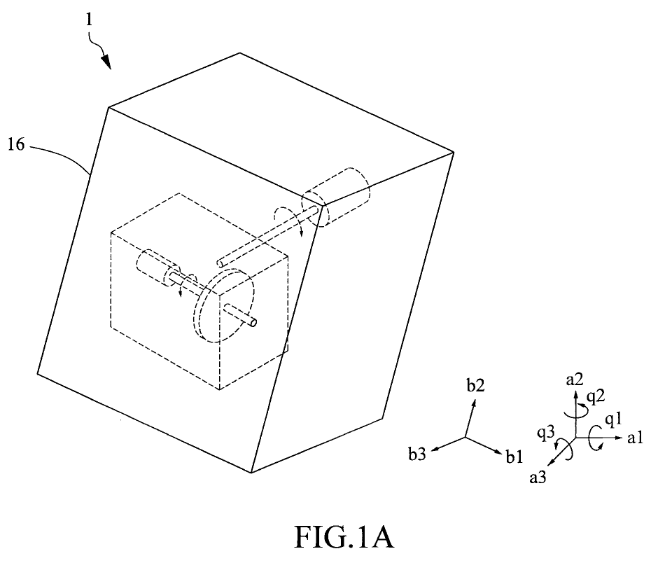

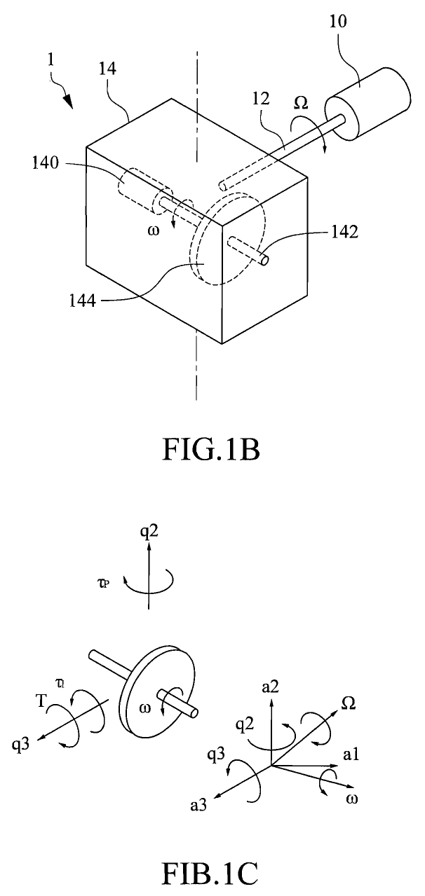

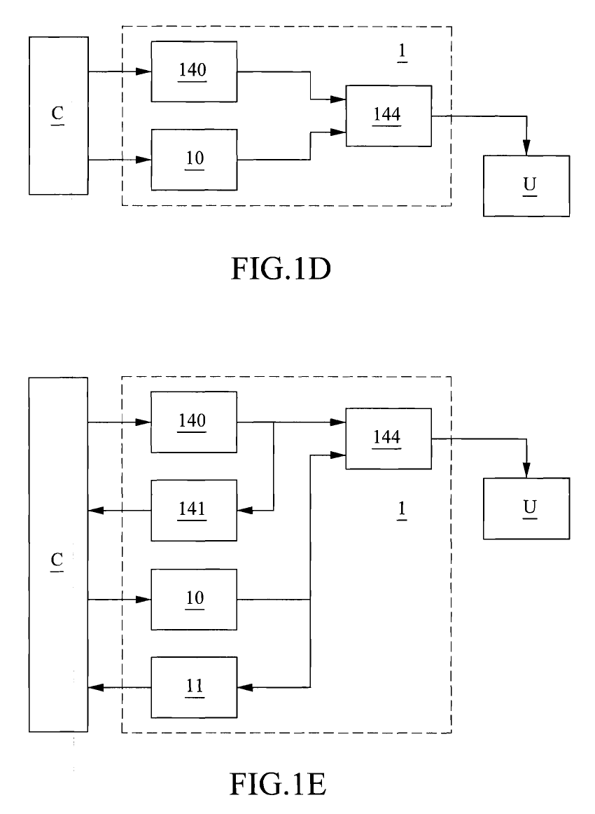

Please refer to FIG. 1A, FIG. 1B and FIG. 1C, which show a device with spatially unrestricted force feedback according to an exemplary embodiment of the present invention. In the embodiment shown in FIG. 1A, the hull 16 of the force feedback device 1 is shaped like a box, but is not limited thereby. It is noted that the force feedback device 1 can be configured with at least one actuator. Generally, the force feedback device 1 has an interface circuit which is used for connecting with an external sensing/control unit. Moreover, it is common to have a micro control unit, a driving circuit and a sensing unit to be integrated inside the force feedback device 1 for motion detection and closed-loop control. As shown in FIG. 1, the orthogonal-disposed axes a1, a2 and a3 define a Cartesian coordinate system in a space, about which the rotation vectors (axes) q1, q2 and q3 are defined.

As shown in FIG. 1B, the force feedback device 1 is configured with two actuators, which are the actuator 10 and another actuator 140. The actuators embedded inside the force feedback device 1 can be rotary-type electromechanical actuators, rotary-type pneumatic or hydraulic actuators or piezoelectric actuators. The actuator 10, being addressed as the second actuator, is arranged on the inner wall of the hull 16 and is used for exerting a torque on the gyro assembly 14 through a transmission shaft 12 for driving the same to rotate. The gyro assembly 14, being a momentum/kinetic energy storage unit, is configured with an actuator 140 for providing a rotary torque to the flywheel 144 for driving the same to rotate, in which the actuator 140 is fixedly secured on the inner wall of the gyro assembly 14 while the flywheel 144 is mounted on a shaft 142 so as to rotate about which in a manner that the flywheel 144 is able to rotate inside the gyro assembly 14 along a ω direction, as shown in FIG. 1B. It is noted that, instead of being fixed on the hull 16, the actuator 10 can be mounted on a base which can be designed as a handle for the user to hold on to.

FIG. 1 C illustrates the operating principle of a device with spatially unrestricted force feedback according to an exemplary embodiment of the present invention. When the flywheel 144 is being driven to rotate in a rotation speed of ω by the actuator 140, the gyro assembly 14 is operating just like a gyroscope. In addition, as soon as the gyro assembly 14 is subjected to a torque T from the actuator 10 in a direction opposite to the rotation direction q3, a torque τ_{I} which is of the same magnitude as that of the torque T but in opposite direction will be caused by the gyroscope inertia and is used as force feedback in the invention. Moreover, as the torque T will force the flywheel 144 to rotate against the rotation q3 in a rotation speed of Ω, another torque τ_{P}, referring as gyro moment, in a direction opposite to q2 direction will be caused according to the precession of the gyroscope in the following formula:

τ_{P}=Ω×(Iω)

wherein I is the moment of the inertia of the gyro assembly. From the above formula, it is known that the magnitude of the torque τ_{P} is in direct proportion to the rotation speed Ω and the angular moment Iω while the direction of the torque τ_{P} is perpendicular with those of Iω and Ω so that the direction as well as the magnitude of the torque τ_{P} can be changed simply by changing the rotation speed ω of the flywheel and the rotation speed Ω caused by the actuator 10. The combination of the torque τ_{I} and the torque τ_{P} will form a feedback torque to be used as a force feedback in human-machine interaction as it can exert a directional force feedback on the device housing the same.

Please refer to FIG. 1D, which is a schematic diagram showing a system with spatially unrestricted force feedback utilizing the device of FIG. 1A according to an exemplary embodiment of the present invention. In the system of FIG. 1D, a control signal from an external controller C is fed into the actuator 140 and the actuator 10 of the force feedback device 1 by which the actuator 140 is directed to drive the flywheel 144 to rotate in a rotation speed of ω while the actuator 10 is directed to exert a torque T on the flywheel 144 for causing precession, and as the result, a force feedback can be felt by a user U holding the device.

Operationally, the flywheel 144 is being driven to rotate in a constant rotation speed, and no torque will be exerted on the flywheel 144 from the actuator 10 when no force feedback is in demand. But when there is a demand for force feedback, the actuator 10 will output a torque T to cause a specific rotation in a speed of Q according to the force feedback demand as the direction and magnitude of the force feedback is determined by those of the torque T and the rotation Ω. By the precession of gyroscope, the faster the flywheel is rotating, the larger the torque is required from the actuator 10 for tilting the rotation shaft direction of the gyro assembly 14. Thus, the disadvantage of the conventional feedback device as the one disclosed in U.S. Pat. No. 5,754,023 can be avoided, since it is limited by its rated highest rotation speed, that is, when the rotation speeds of the flywheels/motors approach the rated highest rotation speed, it is impossible to drive the flywheel to rotate even faster by increasing the current/voltage input to the motor, and thus the flywheels must be decelerated to resume for preparing the same for another operation. Thereby, the effective operation range for generating the two torques τ_{I} and τ_{P} is enlarged.

Please refer to FIG. 1E, which is a schematic diagram showing a system with spatially unrestricted force feedback utilizing the device of FIG. 1A according to another exemplary embodiment of the present invention. In the system of FIG. 1E, similar to that shown in FIG. 1D, a control signal from an external controller C is fed into the actuator 140 and the actuator 10 of the force feedback device 1 by which the actuator 140 is directed to drive the flywheel 144 to rotate in a rotation speed of ω while the actuator 10 is directed to exert a torque T on the flywheel 144 for causing precession, and as the result, a force feedback can be felt by a user U holding the device. The difference between FIG. 1D and FIG. 1E is that: the system of FIG. 1E has two sensors 141 and 11 which are electrically connected with the two actuators 140 and 10 in respective for detecting the output torque and/or the output rotation speed resulting from the two actuators 140 and 10. In detail, the sensor 141 is designed for detecting only rotation speed, and the other sensor 11 is designed for detecting either torque or rotation speed. In addition, as the two sensors 141 and 11 are electrically connected with the external controller C, the motions of the two actuators 140 and 10 can be detected and provided to the external controller C by the two sensors 141, 11, so that the external controller C is able to perform a closed-loop control according to the detection of the two sensors 141 and 11.

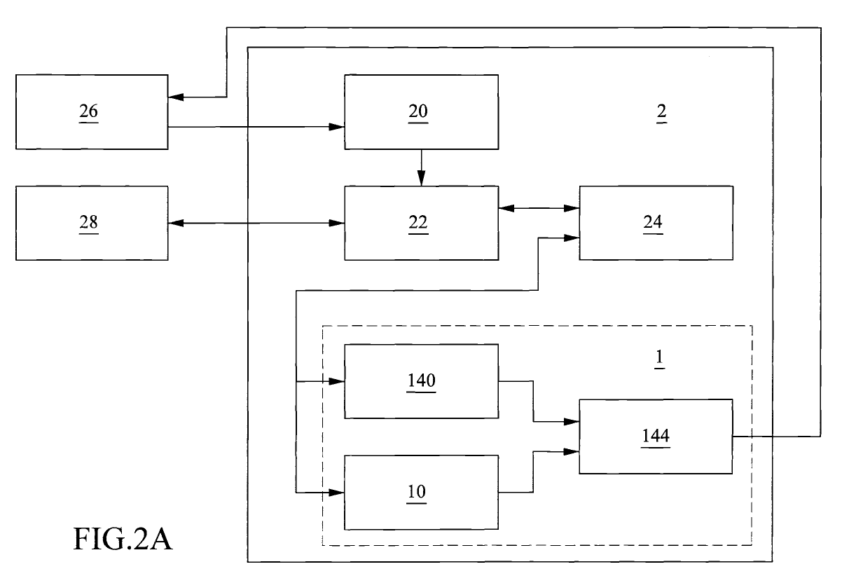

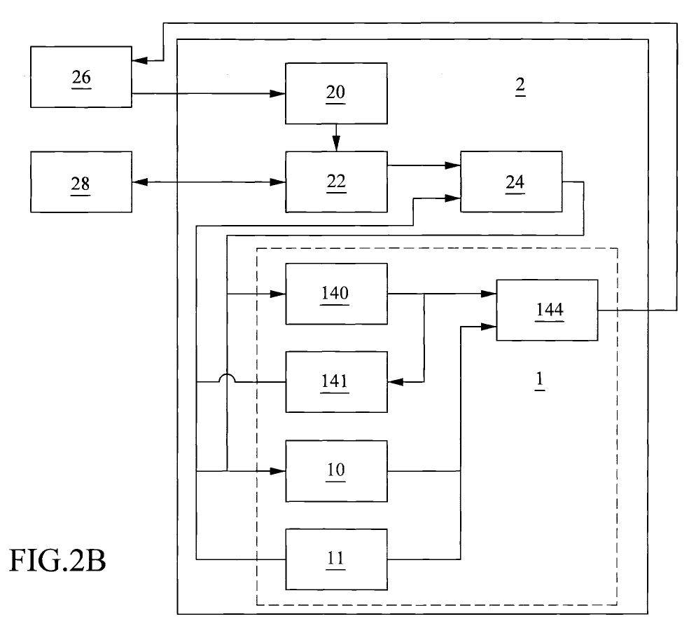

Please refer to FIG. 2A, which is a schematic view showing a system with spatially unrestricted force feedback according to an exemplary embodiment of the present invention. In FIG. 2A, the force feedback system 2 comprises: a force feedback device 1, a sensing unit 20, a control unit 22 and a driving circuit 24, and is further electrically connected with an external simulation engine 28 and is capable of receiving inputs from an user 26. The sensing unit is used for detecting signals originated from the physical attribute of the user 26 as the physical attribute can be the gesture of the user 26 operating the system, the motion of the user 26 affecting the system, or the force originated from the user 26 that is exerted on the system for causing motion. The external simulation engine 28 is used for providing a virtual environment information including spatial coordinate, physical attributes of a virtual object or virtual situations of force response, which are used as calculation reference by the control unit 22. The control unit 22 is designed to perform a calculation according to the information from the external simulation engine 28 and the sensing unit 20 for events such as collision detection, force response calculation and output force/torque control. Thus, the control unit 22 is able to receive feedback signals from the sensing unit 20 in real time while communicating with the external simulation engine 28. Thereby, the control unit 22 can detect continuously at all time about whatever is happening in the virtual environment produced by the external simulation engine, and consequently, in response to the detection, performs a calculation to obtain target force responses for the force feedback device 1. According to the detection and calculation, the control unit 22 will issue a command for directing the force feedback device 1 to output a feedback torque whose magnitude is controlled by the command. It is noted that the power of the command will first be amplified by the driving circuit 24 before it is fed into the force feedback device 1 for directing the same to generate the force feedback to be felt by the user 26.

Generally, the sensing unit 20 or the control unit 22 is not necessary to be integrated in the force feedback system 2. Either of the two can be arranged as an external device that is designed to transmit signals to the driving circuit 24 and the force feedback device 1 through an interface circuit. On the other hand, the force feedback system 2 can act as an actuating unit comprising only the force feedback device 1, the control unit 22 and the driving circuit 24.

Please refer to FIG. 2B, which is a schematic view showing a system with spatially unrestricted force feedback according to another exemplary embodiment of the present invention. The system shown in FIG. 2B is mostly the same as the one shown in FIG. 2A, but is different in that: the system of FIG. 2B has two sensor 141 and 11 which are electrically connected with the two actuators 140 and 10 in respective for detecting the output torque and/or the output rotation speed resulting from the two actuators 140 and 1O. In detail, the sensor 141 is designed for detecting only rotation speed, and the other sensor 11 is designed for detecting either torque or rotation speed. In addition, as the two sensors 141 and 11 are electrically connected with the driving circuit 24, the motions of the two actuators 140 and 10 can be detected and sent to the driving circuit 24 by the two sensors 141, 11. Thereby, the driving circuit 24 is able to base upon the feedbacks of the two sensors 141, 11 and the commands from the control unit 22 to enable the controllers embedded in the driving circuit 24 to issue driving signals for controlling the actuations of the two actuators 140 and 10 in a closed-loop control manner.

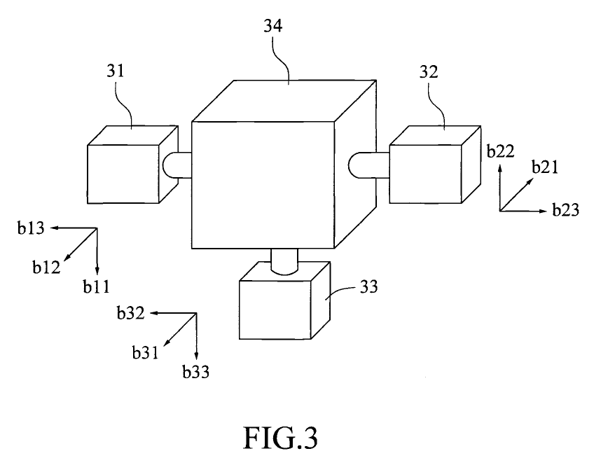

Moreover, the force feedback device of the invention can be applied in a three-axes system as the one shown in FIG. 3. In the embodiment shown in FIG. 3, there are three single-axis force feedback devices 31, 32, 33 being arranged at three different sides of a frame 34, in which the flywheel shafts of the three force feedback device 31, 32, 33 are respectively being directed by the three arrows b11, b21 and b31, and the rotation shaft of the second actuators of the three force feedback device 31, 32, 33 are respectively being directed by the three arrows b13, b23 and b33, and the reference directions of the resulting feedback torques are respectively being directed by the three arrows b12, b22 and b32. By matching the aforesaid structure with proper sensing device and control unit, there can be three feedback responses of different directions originated from the three single-axis force feedback devices 31, 32, 33 to be exerted on the frame 34 for interaction.

Other than the disc-like flywheel as those shown in the aforesaid embodiments, flywheels of other shapes can be used in the force feedback device of the invention, such as a ball-shaped flywheel, or an oval-shaped flywheel, etc., only if it is in a shape capable of generating an angular momentum while rotating. Moreover, the sensing unit used in the invention can be an accelerometer, a gyroscope, or any image-based motion sensing facility; and the driving circuit in the force feedback system of the invention further includes a rotation controller for controlling the rotation speed of the flywheel and/or a torque controller for controlling the torque outputted from the actuator connecting to the gyro assembly.

From the above description, it is noted that the device with spatially unrestricted force feedback of the invention is a force feedback device capable of using its rotating flywheel in its gyro assembly as well as the gyroscopic inertia and precession of gyroscope to generate a continuous feedback torque without having to be arranged at a fixed end as those conventional force feedback joysticks. It is advantageous in that: the frame where the force feedback device is attached to is not required to the fixed so that the frame can be a mobile platform as well as a portable platform, such as a device like a wireless joystick, a personal digital assistant (PDA) or a cellular phone, or even can be a gaming toy or exercise equipment. In addition, as the force feedback device of the invention is able to produce directional force feedbacks, it can be used for simulating a comparatively more complex scenario with haptic perception which is not possible in those conventional devices.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device with spatially unrestricted force feedback, comprising:
a base;
a gyro assembly, including a first actuator and a flywheel; and
a second actuator;
wherein, the first actuator is connected with the flywheel by a first shaft for driving the same to rotate; the second actuator is disposed fixedly on the base while connecting to the gyro assembly by a second shaft for exerting a torque to the same; and the first shaft and second shaft are arranged perpendicular to each other.

2. The device of claim 1, further comprising:
a third actuator, fixed on a second base while coupling to the base having the second actuator fixed therein by a rotation shaft, capable of exerting a torque on the base for enabling the same to rotate accordingly as the rotation shaft of the third actuator is disposed orthogonal to the first shaft and the second shaft.

3. The device of claim 1, further comprising a plurality of gyro assemblies and a plurality of second actuators.

4. The device of claim 1, wherein the flywheel is formed in any shape capable of generating an angular momentum while rotating.

5. The device of claim 1, wherein the flywheel is shaped like a disc or a ball, and the base is substantially a hollow hull or a handle.

6. The device of claim 1, further comprising:
a first sensor, electrically connected with the first actuator for detecting the outputted torque or the motion of the same.

7. The device of claim 1, further comprising:
a second sensor, electrically connected with the second actuator for detecting the outputted torque or the motion of the same.

8. The device of claim 7, further comprising a plurality of gyro assemblies and a plurality of second actuators.

9. The device of claim 2, further comprising:
a sensing unit, configured with three sensors in a manner that they are electrically connected to the first, the second and the third actuators in respective for detecting the outputted torques or the motions of the three.

10. A system with spatially unrestricted force feedback, being adapted for receiving an external signal, comprising:
a force feedback device, further comprising:
a base;
a gyro assembly, configured with a first actuator and a flywheel in a manner that the first actuator is connected with the flywheel by a first shaft for driving the same to rotate; and
a second actuator, being disposed fixedly on the base while connecting to the gyro assembly by a second shaft for exerting a torque to the same as the first shaft and second shaft are arranged perpendicular to each other;
a driving circuit, electrically connected with the force feedback device for amplifying control signals of the first and the second actuators; and
a control unit, electrically connected with the driving circuit for calculating an force feedback value according to the received external command so as to direct the driving circuit to drive the force feedback device for generating a feedback torque in accordance with the force feedback value.

11. The system of claim 10, further comprising:
a third actuator, fixed on a second base while coupling to the base having the second actuator fixed therein by a rotation shaft and electrically connected to the driving circuit for using the same to amplify the control signal of the third actuator, and thereby capable of exerting a torque on the base for enabling the same to rotate accordingly as the rotation shaft of the third actuator is disposed orthogonal to the first shaft and the second shaft.

12. The system of claim 11, further comprising:
a sensing unit, electrically connected to the control unit for detecting physical attributes of the force feedback device and the external input signal.

13. The system of claim 12, wherein the sensing unit is a device selected from the group consisting of: an accelerometer, a gyroscope, an image based motion detection facility and the combination thereof.

14. The system of claim 10, wherein the force feedback device further comprises:
a sensing unit, electrically connected to the control unit for detecting physical attributes of the force feedback device and the external signal.

15. The system of claim 14, wherein the sensing unit is a device selected from the group consisting of: an accelerometer, a gyroscope, an image based motion detection facility and the combination thereof.

16. The system of claim 10, further comprising a plurality of gyro assemblies and a plurality of second actuators.

17. The system of claim 10, wherein the flywheel is formed in any shape capable of generating an angular momentum while rotating.

18. The system of claim 10, wherein the flywheel is shaped like a disc or a ball.

19. The system of claim 10, wherein the external signal is a signal related to an attribute selected from the group consisting of: force, speed, acceleration, and displacement.

20. The system of claim 10, further comprising:
a first sensor, electrically connected with the first actuator for detecting the outputted torque or the motion of the same.

21. The system of claim 10, further comprising:
a second sensor, electrically connected with the second actuator for detecting the outputted torque or the motion of the same.

22. The system of claim 20, wherein the driving circuit further comprises:
a rotation control unit, for controlling the rotation speed of the flywheel.

23. The system of claim 21, wherein the driving circuit further comprises:
a control unit, for controlling one element selected from the group consisting of:
the output torque of the second actuator, the rotation speed of the second actuator, and the combination thereof.
